(19) United States
(12) Patent Application Publication
(10) Pub. No.: US 2018/0307361 A1
(43) Pub. Date: Oct. 25, 2018

(54) PRESSURE SENSOR AND TOUCH INPUT DEVICE COMPRISING SAME

(71) Applicant: MODA-INNOCHIPS CO., LTD., Ansan-Si, Gyeonggi-Do (KR)

(72) Inventors: In Kil PARK, Seongnam-Si, Gyeonggi-Do (KR); Jun Ho JUNG, Siheung-Si, Gyeonggi-Do (KR)

(21) Appl. No.: 15/771,279

(22) PCT Filed: Oct. 20, 2016
(86) PCT No.: PCT/KR2016/011798

§ 371 Date: Apr. 27, 2018

(30) Foreign Application Priority Data
Oct. 26, 2015 (KR) 10-2015-0148839
Oct. 7, 2016 (KR) 10-2016-0129997

(51) Int. Cl. G06F 3/041; G06F 3/044

(52) U.S. Cl. CPC G06F 3/0414; G06F 3/044; G06F 3/0416

(57) ABSTRACT

The present invention proposes first and second electrode parts spaced apart from each other, an air gap disposed between the first and second electrode parts, and an air gate disposed on one side of the air gap to allow air to be introduced into and discharged from the air gap.

### TECHNICAL FIELD

The present disclosure relates to a touch input device, and more particularly, to a pressure sensor that is capable of detecting a touch position and a touch input device having the same.

### BACKGROUND ART

Various types of input devices are being used for operating electronic devices such as mobile communication terminals. For example, input devices such as a button, a key, and a touch screen panel are being used. The touch screen panel, i.e., a touch sensor may detect the contact of the human body and easily and conveniently operate an electronic device with only light touch and thus be increasing in usage. For example, the touch sensor is used not only for mobile communication terminals but also for operation of device within vehicles.

The touch sensor used in the electronic devices such as the mobile communication terminals may be disposed between a protection widow and a liquid crystal display panel displaying an image. Thus, characters, symbols, and the like are displayed through the window from the light crystal display panel, and when a user touches a corresponding portion, a touch sensor detects the touch position to perform specific processing according to a control flow.

However, in the electronic device using only the touch sensor, a touch error of the user may occur, and thus, an undesired operation may be performed. Thus, there is a need for a method for detecting a touch pressure together with the touch position to reduce the touch error.

### TECHNICAL PROBLEM

The present invention provides a pressure sensor that is capable of detecting a touch position and a touch pressure and a touch input device having the same. The present invention provides a touch sensor that detects a touch position and a touch input device in which a pressure sensor for detecting the touch position and a touch pressure is interlocked to detect the touch position and pressure.

### TECHNICAL SOLUTION

A pressure sensor according to an aspect of the present invention includes: first and second electrode parts spaced apart from each other; an air gap disposed between the first and second electrode parts; and an air gate disposed on one side of the air gap to allow air to be introduced into and discharged from the air gap.

The pressure sensor may further include at least one spacer disposed between the first electrode part and the second electrode part.

The air gate may be disposed on at least one area of the spacer.

The pressure sensor may further include an elastic layer disposed between the first and second electrode parts, wherein the air gap may be provided in the elastic layer.

The air gap may pass through the spacer and at least one area of the elastic layer.

The air gate may have a length of 0.1 mm or more, which corresponds to 1/10 or less of a total length of the spacer.

The pressure sensor may further include a filter disposed on one side of the air gate to prevent moisture or foreign substances from being introduced into the air gap.

A touch input device according to another aspect of the present invention includes: a window; a display unit displaying an image through the window; and a pressure sensor disposed below the display unit to detect a position and a pressure of a touch input, wherein the pressure sensor includes first and second electrode part spaced part from each other, an air gap disposed between the first and second electrode parts, and an air gate disposed on one side of the air gap to allow air to be introduced into and discharged from the air gap.

The touch input device may further include a touch sensor disposed between the window and the display unit.

The touch input device may further include a bracket disposed on at least one of an upper side of the first electrode part, between the first and second electrode parts, and a lower side of the second electrode part.

At least a portion of one of the first and second electrode parts may be disposed on the bracket.

The touch input device may further include a control unit detecting a touch position according to an output of the touch sensor and detects the touch position and a touch pressure according to an output of the pressure sensor.

The control unit for the touch sensor and the control unit for the pressure sensor may be provided in the same IC or respectively provided in ICs different from each other.

The control unit may detect capacitance of a plurality of areas between the first and second electrodes of the pressure sensor according to the touch input to compare the capacitance at a center of the touch input and a peripheral area of the center, thereby detecting a touch pressure.

### ADVANTAGEOUS EFFECTS

The touch input device according to the embodiments of the present invention includes the pressure sensor in which the air gap is formed between the first and second electrode parts, and the air gate is formed so that the air is introduced and discharged through the gas gap. Since the air gate is formed, when the object such as the finger is touched, the air of the air gap may be discharged through the air gate to significantly change in capacitance value at the touch portion, and thus, the touch area may be more easily detected. Also, when the touch of the object is finished, the air may be introduced into the air gap through the air gate, and thus, the air gap may be quickly restored to the reference capacitance value. Thus, the intensity of the touch pressure may also be accurately detected while minimizing the error when the touch position is detected on the touch surface.

In addition, the touch input device according to the present invention may further include the touch sensor. Thus, the touch sensor and the pressure sensor may be driven to be interlocked with each other to more accurately detect the touch position and pressure. That is, the touch sensor and the pressure sensor may detect coordinates in a horizontal direction (i.e., an X direction and a Y direction) at the same time, and the pressure sensor may detect the pressure in a vertical direction (i.e., a Z direction) to more accurately detect the touch position.

### BRIEF DESCRIPTION OF THE DRAWINGS

FIGS. 1 to 3 are schematic views of an electronic device including a touch input device according to an embodiment of the present invention.

FIGS. 4 and 5 are exploded and cross-sectional views of a touch input device including a pressure sensor according to a first embodiment of the present invention.

FIGS. 6 and 7 are schematic views illustrating first and second electrode parts of the pressure sensor according to the first embodiment of the present invention.

FIGS. 8 and 9 are exploded and cross-sectional views of a touch input device including a pressure sensor according to a second embodiment of the present invention.

FIGS. 10 and 11 are exploded and cross-sectional views of a touch input device including a pressure sensor according to a third embodiment of the present invention.

FIGS. 12 and 13 are exploded and cross-sectional views of a touch input device including a pressure sensor according to a fourth embodiment of the present invention.

FIGS. 14 and 15 are exploded and cross-sectional views of the touch input device including a pressure sensor according to a fifth embodiment of the present invention.

FIGS. 16 and 17 are exploded and cross-sectional views of a touch input device including a pressure sensor according to a sixth embodiment of the present invention.

FIGS. 18 and 19 are views illustrating a control configuration of the touch input device according to the embodiments of the present invention.

### MODE FOR CARRYING OUT THE INVENTION

Hereinafter, embodiments of the present invention will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

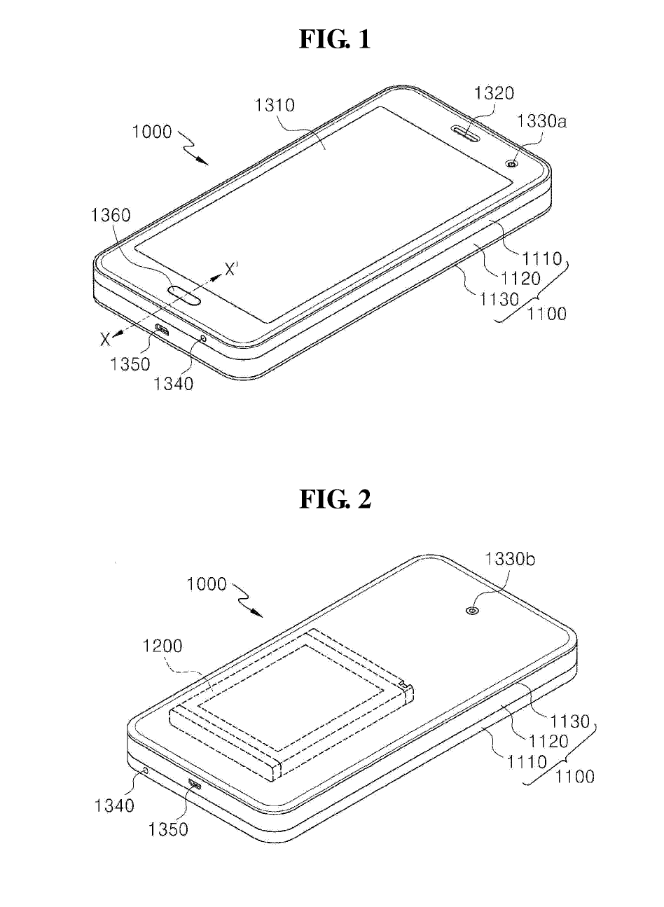

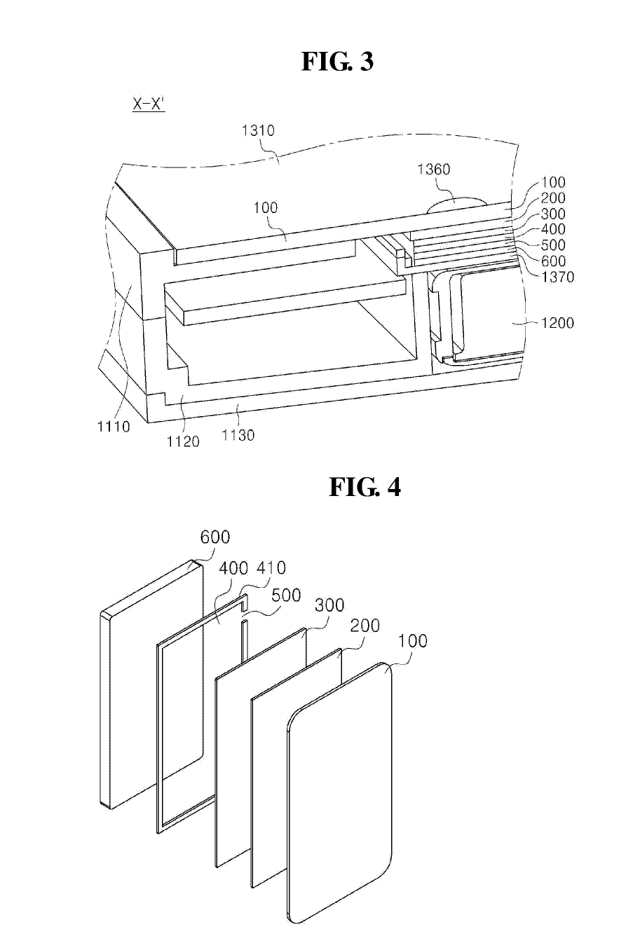

FIGS. 1 and 2 are front and rear perspective views of a mobile communication terminal as an electronic device according to embodiments of the present invention, and FIG. 3 is a partial cross-sectional view taken along line A-A′ of FIG. 1.

Referring to FIGS. 1 to 3, a mobile terminal 1000 includes a case 1100 defining an outer appearance thereof. The case 1100 may include a front case 1110, a rear case 1120, and a battery cover 1130. Here, the front case 1110 may define an upper portion and a portion of a side surface of the mobile terminal 1000, and the rear case 1120 may define a portion of the side surface and a lower portion of the mobile terminal 1000. That is, at least a portion of the front case 1110 and at least a portion of the rear case 1120 may form the side surface of the mobile terminal 1000, and a portion of the front case 1110 may define a portion of a top surface except for a display 1310. Also, the battery cover 1130 may be disposed to cover a battery 1200 disposed on the rear case 1120. The battery cover 1130 may be integrally provided or detachably provided. That is, when the battery 1200 is integrally provided, the battery cover 1130 may be integrally provided. When the battery 1200 is detachably provided, the battery cover 1130 may also be detachably provided. Alternatively, the front case 1110 and the rear case 1120 may be integrated with each other. That is, the case may be provided to close the side surface and the rear surface and expose the top surface without distinguishing the front case 1110 and the rear case 1120 from each other, and the battery cover 1130 may be provided to cover the rear surface of the case 1110. At least a portion of the case 1100 may be formed by injecting a synthetic resin or made of a metal material. That is, at least a portion of each of the front case 1110 and the rear case 1120 may be made of a metal material. For example, a portion forming the side surface of the mobile terminal 1000 may be made of a metal material. Also, the battery cover 1130 may also be made of a metal material. The case 1100 may include, for example, stainless steel (STS), titanium (Ti), aluminum (Al), and the like as the metal material. Various components such as a display, a pressure sensor, a circuit board, a haptic device, and the like of the liquid crystal device may be built in a space defined between the front case 1110 and the rear case 1120.

A display 1310, a sound output module 1320, a camera module 1330a, and the like may be disposed on the front case 1110. Also, a microphone 1340, an interface 1350, and the like may be disposed on side surfaces of the front case 1110 and the rear case 1120. That is, the display 1310, the sound output module 1320, the camera module 1330a, and the like may be disposed on the front surface of the mobile terminal 1000, and the microphone 1340, the interface 1350, and the like may be disposed on the side surface of the mobile terminal 1000. The display 1310 occupies most of the front surface of the front case 1110. That is, the display 1310 is disposed on the front surface of the mobile terminal 1000. Also, the display 1310 may output visual information and input tactile information of the user. The touch input device may be disposed on the display 1310. That is, the touch input device including a window covering a front surface of a terminal body, a display unit outputting the visual information such as the liquid crystal device, and the pressure sensor inputting touch information of the user may be disposed on the display 1310. Also, the touch input device may further include the touch sensor disposed between the window and the display unit. For example, the touch sensor may detect the touch input of the user by providing an insulation layer between a plurality of electrodes in a state in which the plurality of electrodes are disposed to be spaced apart from each other in one direction and the other direction perpendicular to the one direction on a transparent plate having a predetermined thickness. That is, in the touch sensor, the plurality of electrodes may be arranged in a lattice shape to detect capacitance due to the touch input of the user. Here, the touch sensor may detect coordinates in the horizontal direction in which the user's touch is performed, i.e., in the X direction and the Y direction, which are perpendicular to each other, and the pressure sensor may detect coordinates in the vertical direction, i.e., the Z direction as well as the X direction and the Y direction. That is, the touch sensor and the pressure sensor may detect the coordinates in the X direction and the Y direction, and the pressure sensor may further detect the coordinate in the Z direction. Since the touch sensor and the pressure sensor detect the horizontal coordinates at the same time, and the pressure sensor detects the vertical coordinates, the touch coordinates of the user may be more accurately detected. A haptic feedback deice such as a piezoelectric vibration device may be disposed to come into contact with the display 1310 and thereby to react the user's input or touch, thereby providing feedback. Also, the sound output module 1320 and the camera module 1330a may be disposed above the display 1310, and a front input unit 1360 may be disposed below the display 1310. The front input unit 1360 may be constituted by a touch key and a push key, or the front input unit 1350 may be omitted by using the touch sensor or the pressure sensor. That is, the input manipulation of the mobile terminal 1000 may be performed by using the touch sensor or the pressure sensor. Also, although not shown, a power unit and a side input unit may be further disposed on the side surface of the mobile terminal 1000. For example, the power unit and the side input unit may be respectively disposed on two side surfaces facing each other of the electronic device or may be disposed to be spaced apart from each other on one side surface. The power unit may be used to turn on/off the electronic device and also used to enable or disenable a screen. Also, the side input unit may be used to adjust intensity of sound outputted from the sound output module 1320. The pressure sensor may be disposed on an area except for the display unit 200. For example, at least one pressure sensor for detecting pressures of the sound output module 1320 and the camera module 1330a, which are disposed in the upper portion of the electronic device, for controlling a pressure of the front input unit 1360, which is disposed in the lower portion of the electronic device, and for controlling pressures of the power unit and the side input unit, which are disposed on the side surface of the electronic device may be further provided.

As illustrated in FIG. 2, the camera module 1330b may be additionally mounted on a rear surface of the terminal body, i.e., the rear case 1120. The camera module 1330b may have a photographing direction different from that of the first camera 1330a and be a camera having a pixel different from that of the camera module 1330a. A flash (not shown) may be disposed adjacent to the camera module 1330b.

The battery 1200 may be disposed between the rear case 1120 and the battery cover 1300 and may be fixed or detachably disposed. Here, the rear case 1120 may be formed by being recessed to insert the battery 1200 therein. After the battery 1200 is mounted, the battery cover 1130 may be disposed to cover the battery 1200 and the rear case 1120.

As illustrated in FIG. 3, a bracket 1370 may be disposed between the display 1310 and the rear case 1130, and the window 100, the display unit 200, and the pressure sensor including the first electrode part 300, the air gap 400, the air gait 500, and the second electrode part 600 may be disposed on the bracket 1370. That is, the touch input device according to the present invention may be disposed on the bracket 1370 of the display 1310, and the bracket 1370 may support the touch input device. Also, the touch sensor may be further disposed between the window 100 and the display unit 200. Here, the bracket 1370 may be used as a portion of the touch input device.

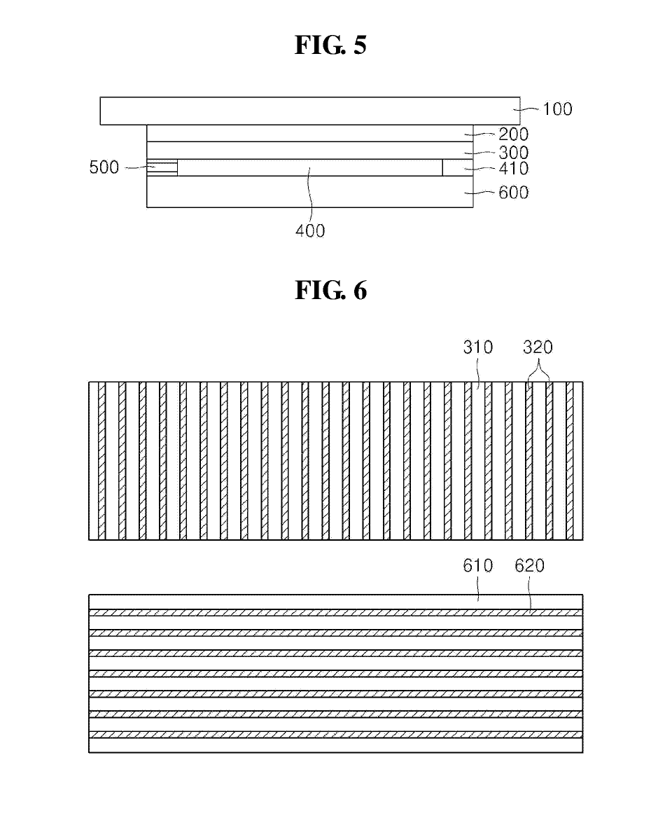

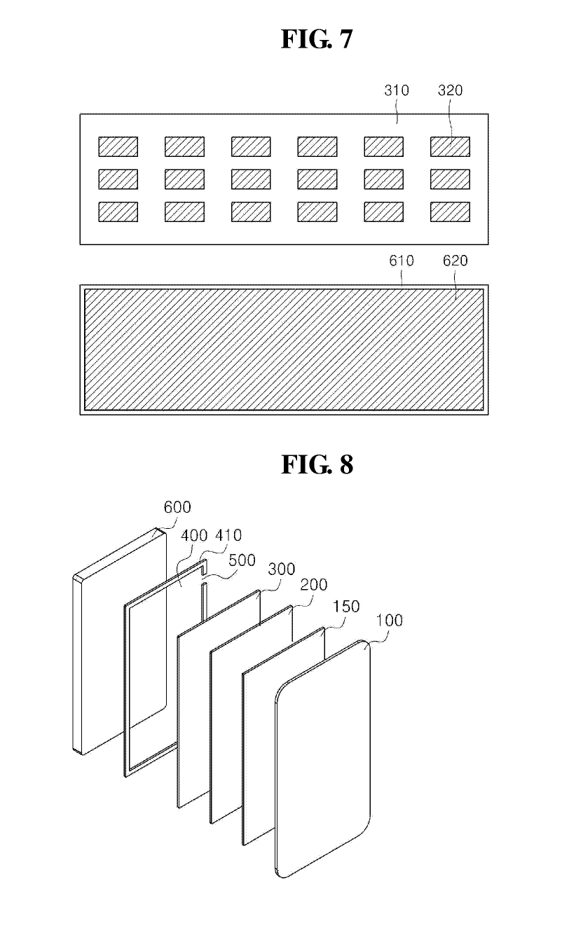

FIGS. 4 and 5 are exploded and cross-sectional views of a touch input device including a pressure sensor according to a first embodiment of the present invention. Also, FIGS. 6 and 7 are schematic views illustrating first and second electrode parts of the pressure sensor according to the first embodiment of the present invention.

Referring to FIGS. 4 and 5, a touch input device according to a first embodiment of the present invention may include a window 100, a display unit 200 disposed below the window 100, a first electrode part 300 disposed below the display unit 200 and provided with a first electrode 320, an air gap 400 disposed below the first electrode part 300, an air gate 500 disposed at one side of the air gap 400, and a second electrode part 600 disposed below the air gap 400 and provided with a second electrode 620. Also, a touch sensor (not shown) may be further provided between the window 100 and the display unit 200. The touch input device may be disposed on the bracket 1370 of the display 1310, and the first electrode part 300, the air gap 400, the air gate 500, and the second electrode part 600 may constitute the pressure sensor. Also, although not shown, the touch input device may further include a control unit including a driving part applying driving power to the first electrode part and a detection part receiving a signal including information with respect to capacitance that varies according to touch on a touch surface of the touch input device to detect a touch position and a touch pressure on the touch source of the touch input device.

The window 100 is disposed on the display unit 200 to come into contact with an object such as a finger, a stylus pen, and the like. The window 100 may be made of a transparent material, for example, an acrylic resin, glass, and the like.

The display unit 200 displays an image to a user through the window 100. The display unit 200 may include a liquid crystal display (LCD) panel, an organic light emitting display (OLED) panel, and the like. When the display unit 200 includes the liquid crystal display panel, a backlight unit (not shown) may be disposed below the display unit 200. The backlight unit may include a reflection sheet, a light guide plate, optical sheet, and a light source. A light emitting diode (LED) may be used as the light source. Here, the light source may be disposed below or on a side surface of a structure in which the reflection sheet, the light guide plate, and the optical sheet are laminated. A liquid crystal material of the liquid crystal display panel may react with light emitted from the backlight unit to output a character or image due to the inputted signal. A light shielding tape (not shown) may be attached between the display unit 200 and the backlight unit to block light. The light shielding tape may have a shape in which an adhesive is applied to both side surfaces of a polyethylene film. The display unit 200 and the backlight unit may adhere to the adhesive of the light shielding tape to prevent the light emitted from the backlight unit from leaking to the outside of the display unit 200 by the polyethylene film inserted into the light shielding tape.

The first electrode part 300 may be formed by forming a conductive layer having a predetermined pattern on a predetermined plate. As illustrated in FIGS. 6 and 7, the first electrode part 300 may include a first support layer 310 and a first electrode 320 disposed on the first support layer 310. The first support layer 310 may support the first electrode 320 so that the first electrode 320 is formed on one surface thereof. For this, the first support layer may have a plate shape having a predetermined thickness. Also, the first support layer 310 may be provided in a film shape having a flexible property so as to have elastic force and restoring force. The first support layer 310 may include a liquid polymer such as silicon, urethane, polyurethane, and the like. Also, the first support layer 310 may be formed by using a prepolymer using photocurable monomer, oligomer, photoinitiate, and additives. In some cases, the first support layer may be transparent or opaque. As illustrated in FIG. 6, the first electrode 320 may be provided in plurality, and the plurality of electrodes 320, each of which has a predetermined width, may be arranged to be spaced apart from each other in one direction. As illustrated in FIG. 7, each of the plurality of electrodes may have a rectangular pattern shape having a predetermined with and distance in one direction and the other direction. Here, as illustrated in FIG. 6, the second electrodes 620 facing the first electrodes 320 may be arranged to be spaced a predetermined distance from each other in a direction perpendicular to the first electrodes 320. As illustrated in FIG. 7, the second electrodes 620 may be entirely provided. Alternatively, the first electrodes 320 may be formed on the first support layer 310 on the whole. On the other hand, each of the second electrodes 620 may have an approximately rectangular pattern shape having a predetermined width and distance. Also, the first electrodes 320 may be disposed on a lower edge of the display unit 200. That is, the first electrodes 320 may be disposed to be spaced apart from each other in the vicinity of four corner areas under the display unit 200. The first electrode 320 may be made of a transparent conductive material such as indium tin oxide (ITO) and antimony tin oxide (ATO). However, the first electrode 320 may be made of a transparent conductive material different from the above-described material or made of an opaque conductive material such as copper, gold, and silver. For example, the first elected 320 may have a thickness of 0.1 μm to 50 μm and a distance of 1 μm to 10,000 μm. Also, when the first electrodes 320 are disposed to be spaced apart from each other in the vicinity of the lower corners of the display unit 200, a distance between the first electrodes 320 may be 10,000 μm or more. The first electrode part 300 may be adjusted in distance with respect to the first electrode part 300 by the touch or push of the object and thus changed in capacitance. The first electrode part 300 may be disposed between the display unit 200 and the backlight unit. In this case, the first electrode part 300 may be preferably made of a transparent conductive material. Also, the air gap 400 and the second electrode part 600 as well as the first electrode part 300 may be disposed between the display unit 200 and the backlight unit. That is, the first electrode 320, the air gap 400, and the second electrode 620 may be disposed on the backlight unit. In this case, it is preferable that the compressible layer is also disposed on a side which is transparent or has no interference with light.

The air gap 400 may be disposed between the first electrode part 300 and the second electrode part 600. That is, since a spacer 410 is disposed between the first electrode part 300 and the second electrode part 600, the air gap 400 may be disposed between the first electrode part 300 and the second electrode part 600. That is to say, the air gap 400 may be disposed inside the spacer 410 between the first electrode part 300 and the second electrode part 6000. Also, at least one spacer 410 may be further disposed in the inside as well as an edge between the first and second electrode parts 300 and 600. That is, the spacer 410 may be disposed along the edge between the first and second electrode parts 300 and 600, and then at least one spacer may be further disposed inside the spacer 410. For example, the spacer 410 having, for example, a linear shape may be further disposed inside an area disposed along the edge, and at least one may be further disposed in a direction perpendicular to the spacer 410. Also, the spacer 410 may be provided in at least one close loop shape to be sealed together with the first and second electrode parts 300 and 600. That is, the spacer 410 may be disposed in a first close loop shape along the edge between the first and second electrode parts 300 and 600 and be further disposed in a second close loop shape inside the first close loop shape. Also, the spacer 410 may be provided in plurality to be spaced a predetermined distance from other on a plurality areas between the first and second electrode parts 300 and 600. For example, at least one spacer 410 having a cylindrical shape may be disposed between the first and second electrode parts 300 and 600. Thus, a plurality of air gaps 400 may be provided by the plurality of spacers 410 between the first and second electrode parts 300 and 600. Here, the spacer 410 may be made of a material having elastic force and restoring force. For example, the spacer 410 may be formed by using silicon, rubber, a double-sided tape, gel, a Teflon tape, and urethane, each of which has hardness of 30 or less. Also, the spacer 410 may include a spring. Upper and lower portions of the spacer 410 may adhere to each other by an adhesion layer. For example, the spacer 410 may be made of silicon. An adhesive such as a double-sided tape may be disposed on top and bottom surfaces of the spacer 410, and thus, the spacer 410 may adhere to the first electrode part 300 and the second electrode part 600. Alternatively, the spacer 401 may be formed by using only the double-sided adhesion tape. That is, the double-sided tape may be disposed on the edge between the first electrode part 300 and the second electrode part 600, and thus, the first electrode part 300 and the second electrode part 600 may adhere to each other by the double-sided tape. As a result, the spacer 510 may adhere to an elastic body by using the double-sided tape or adhere by using only the double-sided tape. The air gap 400 may be provided in plurality between the first electrode part 300 and the second electrode part 600. That is, the plurality of spacers 410 may be disposed between the first electrode part 300 and the second electrode part 600, for example, in one direction and the other direction perpendicular to the one direction. Thus, the first and second electrode parts 300 and 600 may adhere to each other to provide the plurality of air gaps 400 between the plurality of spacers 410. Here, the plurality of air gaps 400 may be provided in areas in which the plurality of first electrodes 320 of the first electrode part 300 and the plurality of second electrodes 620 of the second electrode part 600 cross each other.

The air gate 500 may be disposed on one side of the air gap 400. For example, the air gate 500 may be disposed on at least a portion of the spacer 410. That is, the air gate 500 may be disposed on at least a portion of the spacer 410 along the edge between the first and second electrode parts 300 and 600. Also, when the spacer 410 is further provided in the inside except for the edge between the first and second electrode parts 300 and 600, the air gate 500 may be disposed on at least a portion of the inner spacer 410. That is, when the spacers 410 are provided in at least two or more close loop shapes, at least one air gate 500 may be disposed on each of the spacers 410. When the spacers 410 are disposed to be spaced a predetermined distance from each other on a plurality of areas, the air gate 500 may be provided to pass through a side surface of each of the spacers 410. Here, a cut region may be formed in at least a portion of the spacer 410, or an opening may be formed in at least a portion to form the air gate 500. The cut region may mean that a predetermined area of the spacer 410 may be removed so that the spacer 410 does not remain in the predetermined area between the first electrode part 300 and the second electrode part 600, and the opening remains in the predetermined area between the first electrode part 300 and the second electrode part 600. That is, the cut region may be formed by spacing one end and the other end of the spacer 410 by a predetermined distance or by removing the spacer 410 in the vertical direction between the first electrode part 300 and the second electrode part 600. As a result, the spacer 410 may not remain in the cut region. Also, the opening may be formed in a predetermined region of the spacer 410, and the spacers 410 above and below the opening may partially remain between the first electrode part 300 and the second electrode part 600. Air may be introduced into or discharged from the air gap 400 through the air gate 500. Here, the air gate 500 may be provided in one or plurality. Since the air gate 500 is provided as described above, when the object is touched, air of the air gap 400 may be discharged through the air gate 500, and thus, the touch pressure may be more clearly detected. Then, when the touch is finished, the air may be introduced into the air gap 400, and the air gap 400 may be quickly restored. Thus, the pressure may be accurately transferred to accurately detect the pressure from small force to large force. That is, when the object is touched, since the air of the air gap 400 is discharged through the air gate 500, the air gap 400 may be more pressed. Thus, a distance between the first and second electrodes 320 and 620 of the first and second electrode parts 300 and 600 may be closer to each other. Thus, each of the first and second electrodes 320 and 620 may be significantly changed in capacitance, and thus, the touch pressure as wall as the touch position may be detected. Although the method for detecting the pressure through the pressure sensor will be described in detail when the control unit is described later, the capacitance in plurality of the plurality areas between the first and second electrodes 320 and 620 may be detected to compare capacitance between a center and a surrounding area of the touch input, thereby detecting the touch pressure. Also, the air gate 500 may have a length of 0.1 mm or more, i.e., a length of 1/10 or less of the total length of the spacer 410. When the air gate 500 has a length less than 0.1 mm, the inflow and outflow of the air are slight so that the inflow and outflow times of the air are prolonged to increase a time responding to the touch of the user. Also, when the air gate has a length exceeding 1/10 of the total length of the spacer 410, fine dust or moisture may be introduced into the air gap 400. To solve this problem, a filter (not shown) for preventing the fine dust or moisture from being introduced into the air gap 400 may be provided in the air gate 500. That is, the filter may be provided to prevent the air from being introduced into or discharged from the air gap 400 and also prevent the fine dust or moisture from being introduced into the air gap 400.

The second electrode part 600 may be formed by forming a conductive layer having a predetermined pattern on a predetermined plate. As illustrated in FIGS. 6 and 7, the second electrode part 600 may include a second support layer 610 and a second electrode 620 disposed on the second support layer 610. The second support layer 610 may support the second electrode 620 so that the second electrode 620 is formed on one surface thereof. For this, the second support layer 610 may have a plate shape having a predetermined thickness. Here, the second support layer 610 may have elastic force and restoring force, like the first support layer 310. However, the second support layer 610 may not have the elastic force and the restoring force, unlike the first support layer 310. That is, since only the first support layer 310 is elastically deformed by the force pushing the object, the second support layer 610 may have a rigid property. In some cases, the second support layer 610 may be transparent or opaque. Here, as illustrated in FIG. 6, the second electrodes 620 may be arranged to be spaced a predetermined distance from each other in a direction perpendicular to the first electrodes 320. As illustrated in FIG. 7, the second electrodes 620 may be entirely provided. Alternatively, the first electrodes 320 may be formed on the first support layer 310 on the whole. On the other hand, each of the second electrodes 620 may have an approximately rectangular pattern shape having a predetermined width and distance. Also, the second electrode 620 may be disposed on a lower edge of the display unit 200. That is, the second electrodes 620 may be disposed to be spaced apart from each other in the vicinity of four corner areas under the display unit 200 or may be disposed to face the first electrodes 320. Alternatively, the first and second electrodes 320 and 620 may be disposed to face each other on an area except for the display unit 200 to provide the pressure sensor outside the display unit 200. For example, at least one pressure sensor for detecting pressures of the sound output module 1320 and the camera module 1330a, which are disposed in the upper portion of the electronic device, for controlling a pressure of the front input unit 1360, which is disposed in the lower portion of the electronic device, and for controlling pressures of the power unit and the side input unit, which are disposed on the side surface of the electronic device may be further provided. The second electrode 620 may be made of a transparent conductive material such as indium tin oxide (ITO) and antimony tin oxide (ATO). However, the second electrode 620 may be made of a transparent conductive material different from the above-described material or made of an opaque conductive material such as copper, silver, and gold. For example, the second elected 620 may have a thickness of 0.1 μm to 50 μm and a distance of 1 μm to 10,000 μm. Also, when the second electrodes 620 are disposed to be spaced apart from each other in the vicinity of the lower corners of the display unit 200, a distance between the second electrodes 320 may be 10,000 μm or more. The second electrode part 600 may apply a ground potential through the second electrode 620. That is, a signal of a predetermined potential may be applied through the first electrode part 300, and the ground potential may be applied to the second electrode part 600. The first electrode part 300 may be elastically deformed with respect to the second electrode part 600 by the touch or push of the object to adjust a distance between the first and second electrode parts 300 and 500, thereby changing the capacitance. The air gap 400 and the second electrode part 600 as well as the first electrode part 300 may be disposed between the display unit 200 and the backlight unit. That is, the first electrode 320, the air gap 400, and the second electrode 620 may be disposed on the backlight unit.

A driving part (not shown) may apply a driving signal to the first electrode part 300. For example, the driving signal may be successively applied to the plurality of first electrodes 310 that are spaced a predetermined distance from each other in one direction. The driving signal may be repeatedly applied. That is, the driving signal may be successively applied from the first electrode disposed on one edge to the first electrode 310 disposed on the other edge that is away from the one edge. However, the driving signal may be applied to the plurality of first electrodes 310 at the same time. Here, the detection part (not shown) may receive information with respect to the capacitance through the first electrode part 300 or the second electrode part 600 to detect a variation in capacitance.

When the object such as the finger or stylus pan approaches the touch input device, a value of the capacitance between the first electrode part 300 and the second electrode part 600 may vary. Thus, the detection part may detect the electrical characteristics to detect whether touch occurs with respect to the touch input device or the touch position. For example, whether the touch occurs with respect to the touch input device and/or the touch position may be detected on a two-dimensional plane defined in one direction and the other direction perpendicular to the one direction.

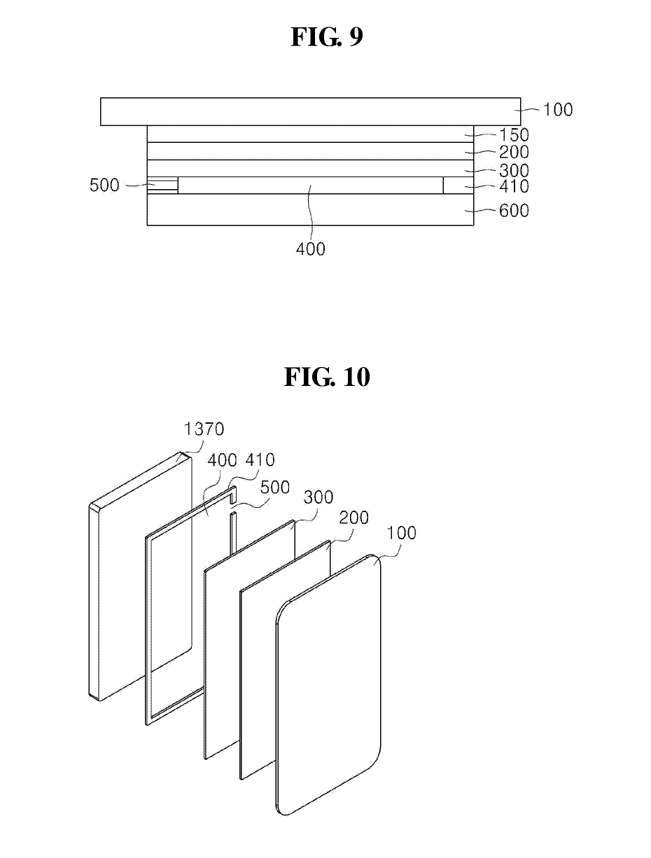

Also, as illustrated in FIGS. 8 and 9, the touch sensor 150 may be further disposed between the window 100 and the display unit 200. For example, the touch sensor 150 may detect the touch input of the user by providing an insulation layer between a plurality of electrodes in a state in which the plurality of electrodes are disposed to be spaced apart from each other in one direction and the other direction perpendicular to the one direction on a transparent plate having a predetermined thickness. That is, in the touch sensor 150, the plurality of electrodes may be arranged in a lattice shape to detect capacitance due to the touch input of the user. Thus, the touch sensor 150 may detect coordinates in the horizontal direction in which the user performs the touch, i.e., the X direction and the Y direction, which are perpendicular to each other. The electrode to the touch sensor 150 may have the shape as illustrated in FIGS. 6 and 7. That is, the touch sensor 150 may have the same shape as each of the first and second electrodes 320 and 620 of the first and second electrode parts 300 and 600 of the pressure sensor.

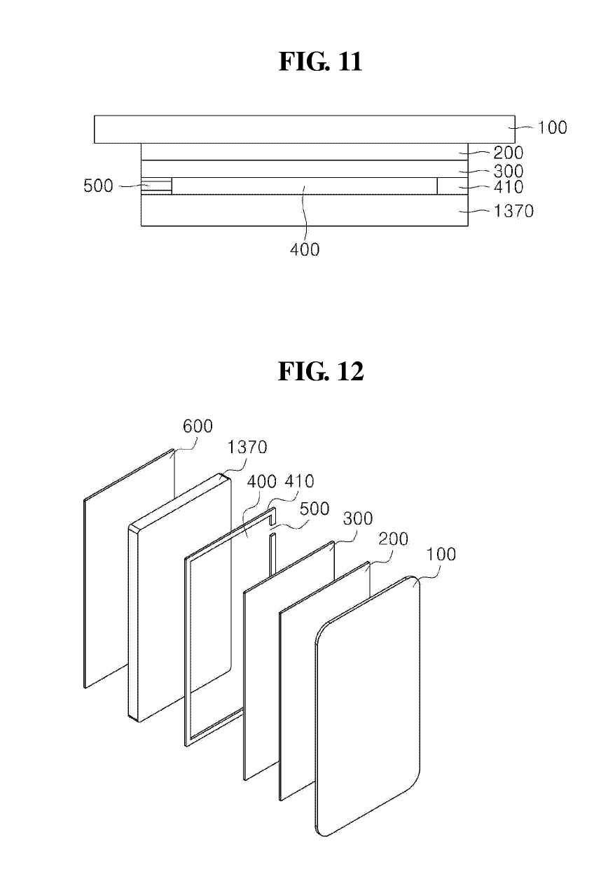

One of the first and second electrode parts 300 and 600 of the present invention may be disposed on a bracket 1370. That is, the bracket 1370 may function as the first and second electrode parts 300 and 600. In this case, the first electrode 320 or the second electrode 620 may be disposed on the bracket 1370. Thus, the bracket 1370 may be used as a support layer of the first electrode part 300 or the second electrode part 600. FIGS. 10 and 11 are exploded and cross-sectional views of a touch input device including a pressure sensor according to a third embodiment of the present invention. FIG. 10 illustrates a case in which a second electrode 620 is disposed on a bracket 1370. Here, although not shown, a touch sensor may be further disposed between a window 100 and a display unit 200.

As illustrated in FIG. 3, the bracket 1370 is disposed on a rear case 1120. The bracket 1370 may support the touch sensor that is disposed at an upper side, a display unit 200, a first electrode part 300, and a spacer 410 to prevent force pushing an object from being dispersed. The bracket 1370 may be made of a material that is not deformed in shape. That is, the bracket 1370 may prevent the force pushing the object from being dispersed and support the touch sensor, the display unit 200, the first electrode part 300, and the spacer 410. Thus, the bracket 1370 may be made of a material that is not deformed in shape. Here, the bracket 1370 may be made of a conductive material or an insulation material. Also, an edge or an entity of the bracket 1370 may have a bent or curved structure. As the bracket 1370 is provided as described above, the force pushing the object may not be dispersed but be concentrated. Thus, the touch area may be more accurately detected. Also, the bracket 1370 may be used as the second electrode part. That is, the bracket 1370 may be used as a ground electrode that is changed in capacitance together a potential of the first electrode part 300. Since the bracket 1370 is used as the second electrode part, i.e., the ground electrode, the bracket 1370 may be made of an insulation material, and a second electrode 620 may be disposed on the bracket 1370. As illustrated in FIG. 6, the second electrodes 620 may be arranged to have a predetermined width and distance in one direction and also arranged in a direction crossing the first electrode 320. Also, as illustrated in FIG. 7, the second electrode 620 may be disposed on the entire bracket 1370. Also, although not shown, the second electrode 620 may have a lattice shape. That is, the plurality of second electrodes 620 may extend in one direction and the other direction perpendicular to the one direction. Here, the second electrode 620 disposed on the bracket 1370 may overlap at least a portion of the first electrode 320 of the first electrode part 300. That is, the first and second electrodes 350 and 520 may overlap each other so that the capacitance varies according to a change in distance between the first and second electrodes 320 and 620. The second electrode 620 disposed on the bracket 1370 may be made of a transparent conductive material. However, the second electrode 620 may be mode of an opaque conductive material such as copper, silver, and gold. The bracket 1370 may apply a ground potential through the second electrode 620. That is, a signal of a predetermined potential may be applied through the first electrode part 300, and the ground potential may be applied to the bracket 1370. Thus, a distance between the first electrode part 300 and the bracket 1370 may decrease according to the touch of the object when compared to a reference distance, and thus, the capacitance between the first electrode part 300 and the bracket 1370 may vary.

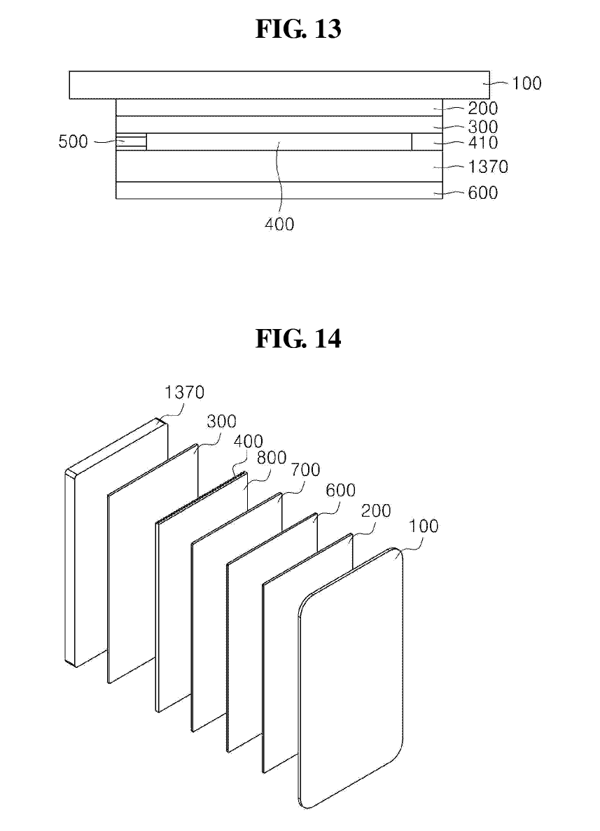

Also, the second electrode part 600 may be disposed below the bracket 1370. That is, as illustrated in FIGS. 12 and 13, a touch input device including a pressure sensor according to a fourth embodiment of the present invention may include a window 100, a display unit 200, a first electrode part 300, an air gap 400, an air gate 500, a bracket 1370, and a second electrode 600. Also, although not shown, a touch sensor may be further disposed between the window 100 and the display unit 200.

The second electrode part 600 may be disposed below the bracket 1370. When thee second electrode 620 is disposed on the bracket 1370 and used as a ground electrode, the second electrode part 600 may be disposed below the bracket 1370 to apply a ground potential to the second electrode 620. Alternatively, when the second electrode 620 of the bracket 1370 receives the ground potential from the outside, the ground electrode may be omitted. Also, when the second electrode 620 is not provided on the bracket 1370, the second electrode part 600 may function as the ground electrode. For this, as illustrated in FIGS. 6 and 7, in the second electrode part 600, may be configured so that the second electrode 620 having a predetermined pattern is disposed on a support layer 610 having a predetermined plate shape.

As described above, the second electrode part 600 may be disposed below the bracket 1370. When an electrode is disposed on the bracket 1370 and used as the ground electrode, the second electrode part 600 may be provided to apply a ground potential to the electrode and may constitute a pressure sensor together with a first electrode part 300, an air gap 400, and an air gate 500 with the bracket 1370 therebetween.

In the embodiments of the present invention, the first electrode part 300, the air gap 400, the air gate 500, and the second electrode part 600 may be disposed between the display unit 200 and the bracket 1370. However, the first electrode part 300, the air gap 400, the air gate 500, and the second electrode part 600 may be disposed between the window 100 and the display unit 200 and also between the display unit 200 and a backlight unit. Here, the backlight unit may be disposed between the display unit 200 and the bracket 1370.

As described above, in the pressure sensor according to the first to third embodiments of the present invention, the air gap 400 may be defined between the first and second electrode parts 300 and 600, and an air gate 500 may be provided so that air within the air gap 400 is introduced and discharged. Since the air gate 500 is formed, when an object such as a finger is touched, the air of the air gap 400 may be discharged through the air gate 500 to significantly change in capacitance at the touch portion, and thus, the touch area may be more easily detected. Also, when the touch of the object is finished, the air may be introduced into the air gap 400 through the air gate 500, and thus, the air gap 400 may be quickly restored to a reference capacitance value. Thus, since the pressure sensor is applied to the touch input device, the intensity of the touch pressure may also be accurately detected while minimizing the error when the touch position is detected on the touch surface.

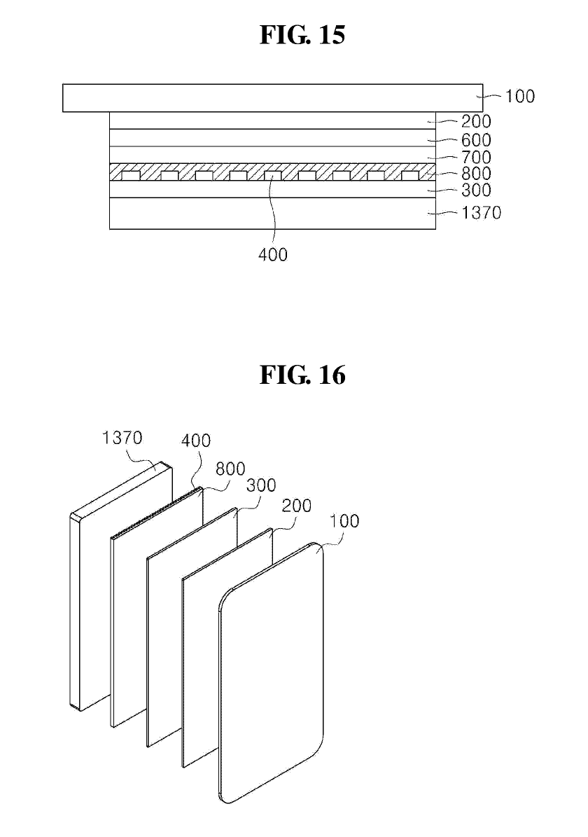

FIGS. 14 and 15 are exploded and cross-sectional views of a touch input device including a pressure sensor according to a fifth embodiment of the present invention.

Referring to FIGS. 14 and 15, a touch input device according to a fifth embodiment of the present invention may include a window 100, a display unit 200 disposed below the window 100, a second electrode part 600 disposed below the display unit 200, a buffer layer 700 disposed below the second electrode part 600, an elastic layer 800 disposed below the buffer layer 700, a plurality of air gaps 400 provided in the elastic layer 800, and a first electrode part 300 disposed below the elastic layer 800. Also, a bracket 1370 may be disposed below the first electrode part 300. Although not shown, a touch sensor may be further disposed between the window 100 and the display unit 200. Here, the bracket 1370 may not be provided with a predetermined electrode that is used as a ground electrode and prevent force pushing an object from being dispersed to other portions. The touch input device according to the fifth embodiment of the present invention will now be described with reference to contents different from those of the first to fourth embodiments of the present invention.

The buffer layer 700 is disposed between the second electrode part 600, which is used as the ground electrode, and the elastic layer 800. The buffer layer 700 may be made of an insulation material such as PI or PET.

The elastic layer 800 may be disposed between the buffer layer 700 and the first electrode part 300 and be made of an elastic material having an elastic restoring force such as silicone, rubber, double-sided tape, gel, foron tape, urethane, spring and the like. Here, the elastic body may be made of a material having hardness of 30 or less. The plurality of air gaps 400 may be defined in the elastic layer 800. The plurality of air gaps 400 may have the size and be disposed to be spaced the same distance from each other. Here, the size and the spaced distance may be the same, or the size may be greater than the spaced distance. For example, one or more air gaps 400 may be provided in areas in which the first electrode 320 of the first electrode part 300 and the second electrode 620 of the second electrode part 600 cross each other. The plurality of air gaps 400 may come into contact with the first electrode part 300 or come into contact with the buffer layer 700. Also, the plurality of air gaps 400 may come into contact with the first electrode part 300 or the buffer layer 700 or be defined in the elastic layer 800. Air may be introduced or discharged through the plurality of air gaps 400. That is, the air gate (not shown) may be disposed on a predetermined area of the elastic insulation layer 800 so that the air is introduced or discharged through the plurality of air gaps 400. For example, when the plurality of air gaps 400 are adjacent to the first electrode part 300, the air gate may be disposed on the elastic layer 800 between the first electrode part 300 and the plurality of air gaps 400.

The structure including the buffer layer 700 and the elastic layer 800 may be implemented by changing positions of the constituents. For example, the window 100, the display unit 200, the first electrode part 300, the elastic layer 800 having the air gaps 400, the buffer layer 700, the bracket 1370, and the second electrode part 600 may be laminated to implement the touch input device. Alternatively, the touch input device may be implemented without the buffer layer 700.

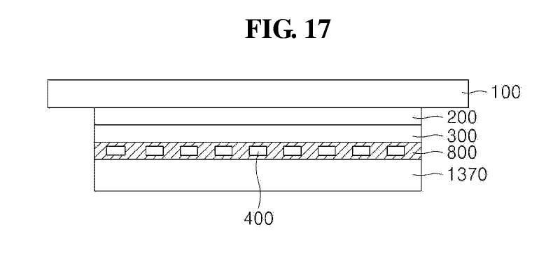

FIGS. 16 and 17 are exploded and cross-sectional views of a touch input device including a pressure sensor according to a sixth embodiment of the present invention.

Referring to FIGS. 16 and 17, a touch input device according to a sixth embodiment of the present invention may include a window 100, a display unit 200 disposed below the window 100, a first electrode part 300 disposed below the display unit 200, an elastic layer 800 disposed below the first electrode layer 300, a plurality of air gaps 400 provided in the elastic layer 800, and a bracket 1370 disposed below the elastic layer 800. Also, although not shown, a touch sensor may be further disposed between the window 100 and the display unit 200. Here, the bracket 1370 may be provided with a second electrode to function as the second electrode part applying a ground potential. That is, when compared to the fourth embodiment of the present invention, in the fifth embodiment of the present invention, a second electrode part 600 and an insulation layer 700 may be provided. Here, the plurality of air gaps 400 may come into contact with the first electrode part 300 or come into contact with the buffer layer 700. Also, as illustrated in FIG. 17, the plurality of air gaps 400 may come into contact with the first electrode part 300 or the buffer layer 700 or be defined in the elastic layer 800.

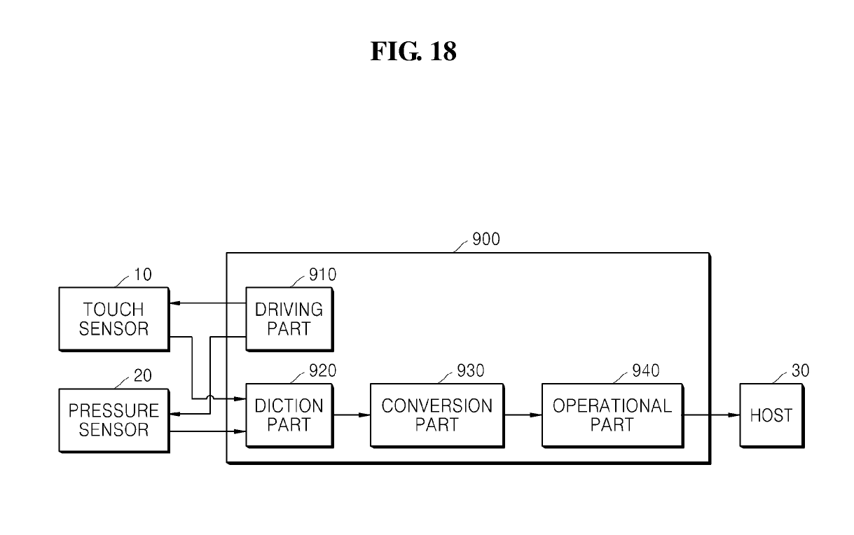

FIG. 18 is a view illustrating a configuration for controlling a touch input device including a touch sensor and a pressure sensor as a control configuration view of the touch input device according to an embodiment of the present invention.

Referring to FIG. 18, the configuration for controlling the touch input device according to an embodiment of the present invention may include a control unit 900 for controlling operations of the touch sensor 10 and the pressure sensor 20. The control unit 900 may include a driving part 910, a detection part 920, a conversion part 930, and an operational part 940. Here, the control unit 900 including the driving part 910, the detection part 920, the conversion part 930, and the operational part 940 may be implemented as one integrated circuit (IC). Thus, outputs of the touch sensor 10 and the pressure sensor 20 may be processed at the same time by using one integrated circuit (IC).

The driving part 910 applies a driving signal to the touch sensor 10 and the pressure sensor 20. The driving part 910 may include a first driving part for driving the touch sensor 10 and a second driving part for driving the pressure sensor 20. That is, the driving part 910 may apply a driving signal to each of the touch sensor 10 and the pressure sensor 20. However, the driving part 910 may be provided in a single type to apply a driving signal to the touch sensor 10 and the pressure sensor 20. That is, the one driving part 910 may apply the driving signal to each of the touch sensor 10 and the pressure sensor 20. Also, the driving signal from the driving part 910 may be applied to one of first and second electrodes constituting the touch sensor 10 and the pressure sensor 20. That is, a predetermined driving signal may be applied to the first electrode of the first and second electrodes of the touch sensor 10 disposed to cross one direction and the other direction, and a predetermined driving signal may be applied to the first electrode of the pressure sensor 20. Here, the driving signals applied to the touch sensor 10 and the pressure sensor 20 may be the same or different from each other. The driving signal may include a square wave, a sine wave, a triangle wave, and the like, each of which has a predetermined period and amplitude and be successively applied to the plurality of first electrodes. Alternatively, the driving part 910 may apply the driving signal to the plurality of first electrodes at the same time or may selectively apply the driving signal to only a portion of the plurality of first electrodes.

The detection part 920 detects an output signal of the touch sensor 10 and an output signal of the pressure sensor 20. That is, the detection part 920 detects capacitance from the plurality of second electrodes of the touch sensor 10 and capacitance from the plurality of second electrodes of the pressure sensor 20. When a predetermined signal is applied to the plurality of first electrodes, and a ground potential is applied to the plurality of second electrodes, which are perpendicular to the first electrodes, the distances between the first and second electrodes may be the same in an initial state, and thus, the first and second electrodes may have the same capacitance. However, when the distance between the first and second electrodes on at least one area decreases by touch of a user, the capacitance therebetween may be greater than that of other portions. Thus, the detection part 920 may detect a variation in capacitance between the first and second electrodes of the touch sensor 10 and the pressure sensor to detect the touch input. Here, the detection part 920 may include a first detection part for detecting the capacitance of the touch sensor 10 and a second detection part for detecting the capacitance of the pressure sensor 20. However, one detection part 920 may detect all capacitance of the touch sensor 10 and the pressure sensor 20. For this, the detection part 920 may successively detect the capacitance of the touch sensor 10 and the pressure sensor 20. The detection part 920 may detect a pressure of the touch input of the user by using the pressure sensor 20. That is, the detection part 920 may detect the capacitance of the touch sensor 10 to detect a touch area, and the pressure sensor 20 may detect the capacitance to detect the touch area and a pressure at the touch area. For example, when the user's finger is touched, a central area to which the largest pressure is transmitted by coming into contact with a center of the finger and a peripheral area to which a smaller pressure is transmitted on the peripheral area of the central area. The largest touch pressure of the user may be transmitted to the central area, and thus, the distance between the first and second electrodes may be shortest. The distance between the first and second electrode on the peripheral area may be greater than that between the first and second electrodes, and thus, the capacitance of the central area may be greater than that of the peripheral area. Thus, the capacitance of the plurality of areas may be detected and compared to each other to detect the central area to which the largest pressure is transmitted and the peripheral area to which the smaller pressure is transmitted. Thus, an area to be touched by the user may be detected to be determined as the central area. Alternatively, an area which is not touched by the user may have an initial capacitance less than that of the peripheral area. The detection part 920 may include a plurality of C-V converters (not shown) each of which includes at least one operational amplifier and at least one capacitor. The plurality of C-V converters may be connected to the plurality of second electrodes of the touch sensor 10 and the pressure sensor 20, respectively. The plurality of C-V converters may output an analog signal by converting the capacitance into a voltage signal. For this, each of the plurality of C-V converters may include an integration circuit for integrating the capacitance. The integrating circuit may integrate the capacitance to change the integrated capacitance into a predetermined voltage, thereby outputting the voltage. When a driving signal is successively applied to the plurality of first electrodes from the driving part 910, the capacitance may be detected at the same time from the plurality of second electrodes, and the C-V converter may be provided by the number of the plurality of second electrodes.

The conversion part 930 may convert the analog signal outputted from the detection part 920 into a digital signal to generate a detection signal. For example, the conversion part 930 may include a time-to-digital converter circuit for measuring a time at which the analog signal outputted from the detection part 920 reaches a predetermined reference voltage level in the form of a voltage to convert the measured time into a detection signal that is a digital signal or an analog-to-digital converter (ADC) circuit for measuring an amount of change of the level of the analog signal output from the detection part 920 for a predetermined time to convert the change amount into a detection signal that is a digital signal.

The operational part 940 determines a contact input applied to the touch sensor 10 and the pressure sensor 20 by using the detection signal. The number and coordinates of touch input applied to the touch sensor 10 and the pressure sensor 20 may be determined by using the detection signal. Also, the pressure of the touch pressure may be determined by using the detection signal. The detection signal serving as a basis for determining the touch input by the operational part 940 may be data obtained by digitizing a change of the capacitance. Particularly, the detection signal may be data indicating a difference between the capacitance when the touch input does not occur and when the touch input occurs.

The touch inputs of the touch sensor and the touch pressure 20 may be determined by using the control unit 900 and then be transmitted to, for example, a main controller of a host 30 of an electronic device. That is, the control unit 900 may generate X and Y coordinate data by using the signal inputted from the touch sensor 10 through the detection part 920, the conversion part 930, and the operational part 940 and generate X and Y coordinate data and Z pressure data by using the signal inputted from the pressure sensor 20. The generated X and Y coordinate data and the generated Z pressure data may be transmitted to the host 30. The host 30 detects the touch and pressure at the corresponding portion by using the X and Y coordinate data and the Z pressure data through the main controller.

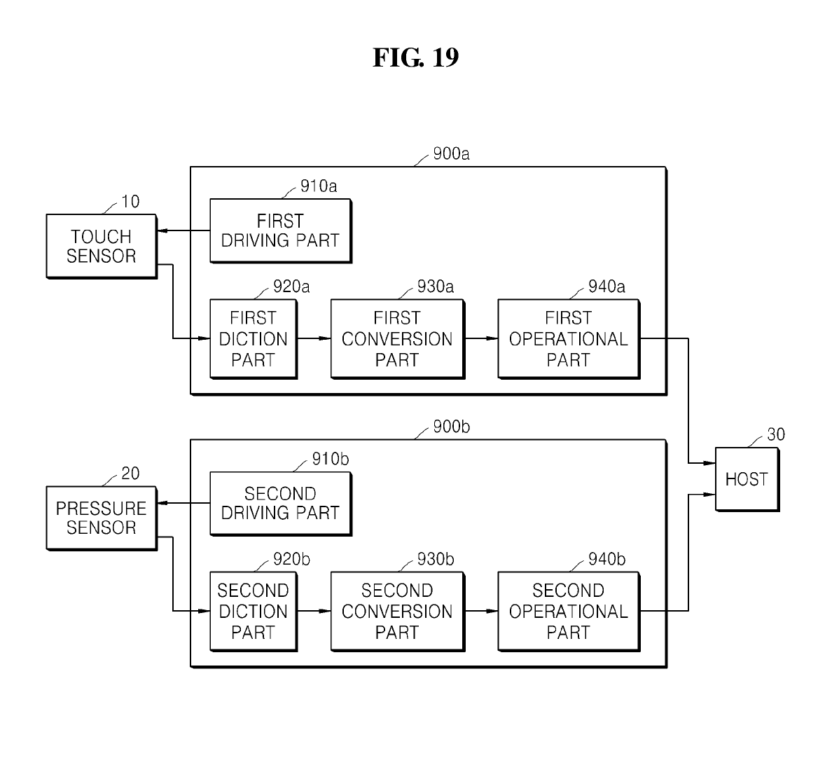

The control unit 900 may include a first control unit 900a processing the output of the touch sensor 10 and a second control unit 900b processing an output of the pressure sensor 20. That is, although one control unit 900 processing the outputs of the touch sensor 10 and the pressure sensor 20 is provided in FIG. 16, as illustrated in FIG. 19, the control unit 900 may include the first and second control units 900a and 900b that respectively process the outputs of the touch sensor 10 and the pressure sensor 20. Here, the first control unit 900a may include a first driving part 910a, a first detection part 920a, a first conversion part 930a, and a first operational part 940, and the second control unit 900b, and the second control unit 900b may include a second driving part 910b, a second detection part 920b, a second conversion part 930b, and a second operational part 940b. The first and second control units 900a and 900b may implement integrated circuits (ICs) different from each other. Thus, two integrated circuits may be necessary for processing the outputs of the touch sensor 10 and the pressure sensor 20. However, the first and second control units 900a and 900b may be implemented by one integrated circuit IC. The configurations and functions of the first and second control units 900a and 900b may separately process the outputs of the touch sensor 10 and the pressure sensor 200 and be the same as illustrated in FIG. 16, and thus, their detailed description will be omitted.

The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims.

1. A pressure sensor comprising:
first and second electrode parts spaced apart from each other, the first and second electrode parts having an air gap disposed therebetween; and
an air gate disposed on one side of the air gap to allow air to be introduced into and discharged from the air gap.

2. The pressure sensor of claim 1, further comprising at least one spacer disposed between the first electrode part and the second electrode part.

3. The pressure sensor of claim 2, wherein the air gate is disposed on at least one area of the spacer.

4. The pressure sensor of claim 2, further comprising an elastic layer disposed between the first and second electrode parts,
wherein the air gap is provided in the elastic layer.

5. The pressure sensor of claim 4, wherein the air gap passes through the spacer and at least one area of the elastic layer.

6. The pressure sensor of claim 3, wherein the air gate has a length of 0.1 mm or more, which corresponds to 1/10 or less of a total length of the spacer.

7. The pressure sensor of claim 3, further comprising a filter disposed on one side of the air gate to prevent moisture or foreign substances from being introduced into the air gap.

8. A touch input device comprising:
a window;
a display unit displaying an image through the window; and
a pressure sensor disposed below the display unit to detect a position and a pressure of a touch input,
wherein the pressure sensor comprises first and second electrode part spaced part from each other, the first and second electrode parts having an air gap disposed therebetween, and an air gate disposed on one side of the air gap to allow air to be introduced into and discharged from the air gap.

9. The touch input device of claim 8, further comprising a touch sensor disposed between the window and the display unit.

10. The touch input device of claim 8, further comprising a bracket disposed on at least one of an upper side of the first electrode part, between the first and second electrode parts, and a lower side of the second electrode part.

11. The touch input device of claim 10, wherein at least a portion of one of the first and second electrode parts is disposed on the bracket.

12. The touch input device of claim 9, further comprising a control unit detecting a touch position according to an output of the touch sensor and detects the touch position and a touch pressure according to an output of the pressure sensor.

13. The touch input device of claim 12, wherein the control unit for the touch sensor and the control unit for the pressure sensor are provided in the same IC or respectively provided in ICs different from each other.
